(19) United States
(12) Patent Application Publication
(10) Pub. No.: US 2011/0016313 A1
(43) Pub. Date: Jan. 20, 2011

(54) HEADER COMPRESSION FOR TUNNELED IPsec PACKET

(75) Inventors: Haipeng Jin, San Diego, CA (US); Jun Wang, La Jolla, CA (US); Lakshminath Reddy Dondeti, San Diego, CA (US); Chandrasekhar T. Sundarraman, San Diego, CA (US); Anan Palanigounder, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/503,442

(22) Filed: Jul. 15, 2009

(51) Int. Cl. H04L 9/00

(52) U.S. Cl. 713/160

(57) ABSTRACT

Aspects describe compressing the concatenation of IP headers, UDP headers, ESP headers, and potentially other headers inside the ESP header. The multiple headers are regarded as one header chain and compressed as a single header chain. The compression can utilize a robust header compression (ROHC) framework. The ROHC ESP profile can be utilized as a basis for compression of ESP/UDP/IP headers with the addition of static chains and dynamic chains for multiple layer transport and application layer headers. Static chains include UDP static header fields either between static IP header fields and static IP header fields or between static IP header fields and static ESP header fields. Dynamic chains include UDP dynamic header fields either between dynamic IP header fields and dynamic ESP header fields or between static IP header fields and static IP header fields.

### BACKGROUND

I. Field

The following description relates generally to wireless communications and more particularly to a header compression profile to compress User Datagram Protocol (UDP) encapsulated Internet Protocol Security (Ipsec) Encapsulating Security Payload (ESP) headers.

II. Background

Wireless communication systems or networks are widely deployed to provide various types of communication; for instance, voice and/or data may be provided through wireless communication systems. A typical wireless communication system, or network, can provide multiple users access to one or more shared resources. For instance, a system may use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Recently, users have started to replace fixed line communications with mobile communications and have increasingly demanded improved voice quality, reliable service, and low prices. In addition to mobile phone networks currently in place, a new class of small base stations has emerged, which may be installed in a user's home and which provide indoor wireless coverage to mobile units using existing broadband Internet connections. Such personal miniature base stations are generally known as access point base stations, or, alternatively, Home Node B (HNB) or femtocells. Typically, such miniature base stations are connected to the Internet and the mobile operator's network through a DSL router or a cable modem.

Security of communications though the small base stations can be a concern especially with the increased frequency of the use of these small base stations. However, providing security to the packets communicated over the small base stations has increased the overhead of packets being sent since compression of security headers in each packet is not available or, if available, require at least two layers of header compression and still only compress a portion of the packets. Thus, the efficiency of communications in such systems has been compromised and overhead can be larger than desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with compressing UDP encapsulated IPsec ESP headers. Aspects relate to extending header compression to allow compression of ESP/UDP/IP headers and a defined header format that can be utilized for compression of these headers.

An aspect relates to a method for header compression in a communication network. Method includes evaluating a header chain for more than one layer of transport layer headers and application layer headers. The more than one layer comprises a User Datagram Protocol header followed by an Internet Protocol Security Encapsulated Security Payload (Ipsec ESP) header. Method also includes creating a context for a chain of the more than one layer of headers and compressing the more than one layer of headers as a single header chain to produce a compressed packet. The compressed packet is communicated to a receiver device.

Another aspect relates to a communications apparatus that includes a memory and a processor. The memory retains instructions related to identifying two or more layers of headers that comprise a User Datagram Protocol header followed by an Internet Protocol Security Encapsulated Security Payload header. The memory retains further instructions related to concatenating the multiple layers of headers, compressing the concatenation, and conveying the compressed concatenation in a packet. The packet includes the concatenation and user data. The processor is coupled to the memory and is configured to execute the instructions retained in the memory.

Still another aspect relates to a communications apparatus that compresses user datagram protocol encapsulated IPsec ESP headers. Communications apparatus includes means for reviewing a header chain for User Datagram Protocol headers and IPsec headers and means for creating a context for a chain of the User Datagram Protocol headers and IPsec headers. Apparatus also includes means for concatenating the IP headers and IPsec headers into a single header chain. Further, apparatus includes means for compressing the single header chain and means for communicating the compressed chain with payload data. In accordance with some aspects, apparatus includes means for establishing a static chain and a dynamic chain for each of the IPsec headers.

Yet another aspect relates to a computer program product, comprising a computer-readable medium. The computer-readable medium includes a first set of codes for causing a computer to evaluate a header chain for multiple layers of transport and application layer headers. The multiple layers comprise a User Datagram Protocol header followed by Internet Protocol Security Encapsulated Security Payload (Ipsec ESP) header. Computer-readable medium also includes a second set of codes for causing the computer to create a context for a chain of the multiple layers of headers and a third set of codes for causing the computer to compress the multiple layers of headers as a single header chain to produce a compressed packet. Also included in computer-readable medium is a fourth set of codes for causing the computer to communicate the compressed packet to a receiver device.

A further aspect relates to at least one processor configured to compress IPsec headers. Processor includes a first module for identifying multiple layers of headers and a second module for concatenating the multiple layers of headers. The multiple layers of headers comprise a User Datagram Protocol header followed by an Internet Protocol Security Encapsulated Security Payload header. Processor also includes a third module for compressing the concatenation and a fourth module for conveying the compressed concatenation in a packet, wherein the packet includes the concatenation and user data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of the various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a wireless communications environment for header compression, in accordance with an aspect.

FIG. 2 illustrates examples of packets of header compression schemes that can be utilized with the disclosed aspects.

FIG. 3 illustrates a system for header compression in accordance with the various aspects disclosed herein.

FIG. 4 illustrates a method for header compression in a communication network, according to an aspect.

FIG. 5 illustrates a system that facilitates compressing UDP encapsulated IPsec ESP headers in accordance with one or more of the disclosed aspects.

FIG. 6 illustrates a system that facilitates compressing headers in accordance with various aspects presented herein.

FIG. 7 illustrates an example system that compresses user datagram protocol encapsulated IPsec ESP headers in a communication environment that utilizes femtocell base stations, in accordance with an aspect.

FIG. 8 illustrates a wireless communication system in accordance with various aspects presented herein.

FIG. 9 illustrates a multiple access wireless communication system according to one or more aspects.

FIG. 10 illustrates an exemplary wireless communication system, according to various aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE), and the like. A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, and so forth, and/or may not include all of the devices, components, modules, and so on, discussed in connection with the figures. A combination of these approaches may also be used.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete manner.

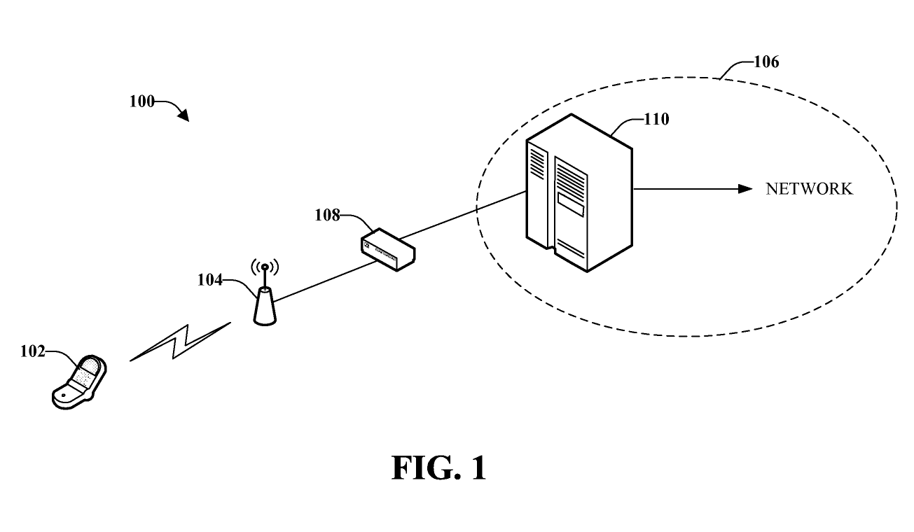

FIG. 1 illustrates a wireless communications environment 100 for header compression, in accordance with an aspect. The disclosed aspects can be utilized with a variety of wireless communications environments (e.g., Wide Area Networks (WAN), Local Area Networks (LAN), Personal Area Networks (PAN) and so forth). Illustrated is a wireless communications environment 100 that utilizes femtocell functionality. “Femtocell” is a term generally used for personal miniature base stations installed in a user's (e.g., subscriber's) residence for providing cellular service within a home environment. However, femtocells can be utilized in a variety of environments (e.g., office, store, coffee shop, library, and so on) and are not limited to a home environment.

Femtocells usually employ radio access network (RAN) functionality (e.g., base transceiver system (BTS), base station controller (BSC), packet data serving node (PDSN), or other network elements) and provide service to a limited number of users. Femtocells can be connected to the Internet and the cellular operator's network through a DSL router, cable modem, or by other techniques.

As illustrated, a mobile device 102 can be in wireless communication with a femtocell base station 104. Both mobile device 102 and femtocell base station 104 are located in user's home or other local area. Although the illustrated mobile device 102 is a cell phone, the disclosed aspects are not limited to cell phones and a multitude of communication devices can be utilized. Femtocell base station 104 (or access point) provides access between mobile device 102 and an operator's network 106. A Network Address Translation (NAT) device 108 is typically deployed between Femto base station 104 and operator's network 106. NAT device 108 is configured to translate an Internet Protocol (IP) address of mobile device 102 to a public address. In accordance with some aspects, NAT device 108 can be in the user's home (or other local area). However, in accordance with some aspects, NAT device 108 may or may not be located in a different location (e.g., either in the user's home or local area or in the DSL, Cable, or other service provider's network). Further, NAT device 108 provides a connection to a gateway 110 and the remaining network, which allows the user to access the Internet. As illustrated, gateway 110 and access to remainder of network is provided by an operator's network 106, represented by the elements in the dotted enclosure.

Since the Internet is a large network, wireless networks are moving in the direction of using IP based transport and, thus, a large amount of users can access the network. A class of applications that can be utilized in IP based transport (and other packet-switched networks) is Voice over Internet Protocol (VoIP), which can also be referred to as IP telephone, Internet telephone, broadband telephone, broadband phone, voice over broadband, and others. Users can utilize VoIP for a variety of communication services, such as voice, voice-messaging applications, facsimile, and so on. These communication services, which were previously transported over public switched telephone networks (PSTN), are transported over the Internet.

A packet is a formatted unit of data that is utilized by packet switched networks. Packets sent utilizing VoIP are IP packets. IP packets carry IP headers, which can be large overhead compared to the payload within the IP packets. For example, in IPv4 (Internet Protocol version 4), around 40 bytes of IP header overhead can be utilized for a single packet. In IPv6 (Internet Protocol version 6), the packet header can be about 60 bytes. When utilizing VoIP, or other real-time services, each voice payload or frame is very small (e.g., around 22 bytes) as compared to the overhead, which is very high. The packet size is not a real concern when a large amount of data is being sent because the amount of data compared to the header itself is so large that the overhead can be ignored. However, when real-time services (e.g., VoIP) are utilized, each voice payload or frame is very small compared to the voice payload, and thus, the overhead is high. There are patterns between IP packets transmitted for a particular VoIP stream (or session), therefore, those headers can be compressed. A mechanism to reduce the amount of overhead that can be utilized is referred to as header compression. Normally, a header can be compressed down to a few bytes, which is a smaller overhead compared to the non-compressed header.

In the case of femtocells, a licensed frequency is utilized to communicate, which belongs to the same operator owning network 106. To achieve security protected traffic over femtocell access point 104, an IP secure channel or IP security association needs to be established between the user equipment (e.g., mobile device 102) and gateway 110, or between femtocell access point 104 and the gateway 110 in operator's network 106. When security is utilized, packets include additional headers in the IP header to provide the security. This security is sometimes referred to an Internet Protocol Security (IPsec), which is a suite of protocols for securing Internet Protocol communication by authenticating and encrypting each IP packet of the VoIP stream. Thus, headers for an IP packet, for example, exchanged between the femtocell access point 104 and the backhaul network, can be large if IPsec is used.

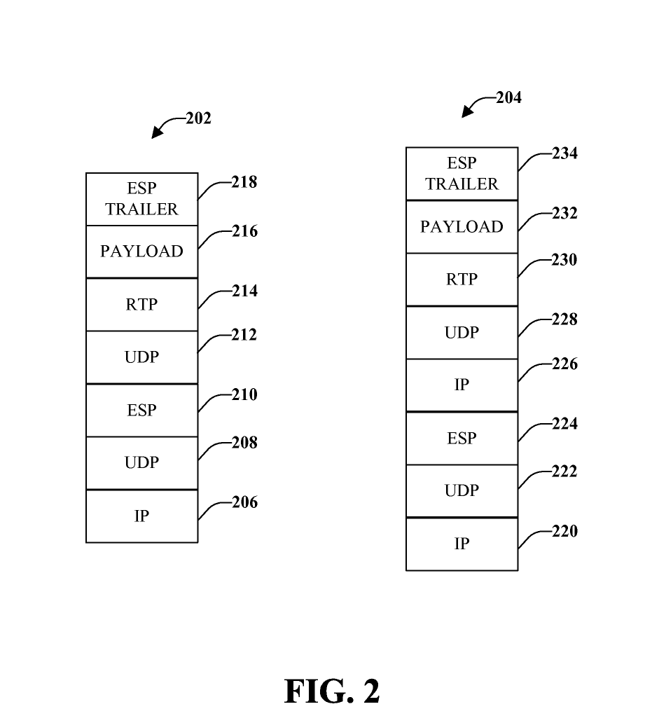

FIG. 2 illustrates examples of packets of header compression schemes that can be utilized with the disclosed aspects. Packets consist of header information and user data (sometimes referred to as payload). Illustrated, at 202, is a User Datagram Protocol (UDP) encapsulated transport mode Encapsulating Security Payload (ESP) packet. ESP is a member of the IPsec protocol suite and provides integrity and confidentially protection of packets.

Included in the UDP encapsulated transport mode ESP packet 202 is an IP header 206, and a UDP header 208, which comprise an encapsulation header. In conventional systems, these headers 206, 208 are the only portions of the packet 202 that can be compressed. However, the packet 202 also includes an ESP header 210, a UDP header 212, and a RTP header 214. These headers 210, 212, and 214 are not compressed in conventional systems, which create large overhead. Also included in the UDP encapsulated transport mode ESP packet 202 is the payload 216 (e.g., voice payload or other user data) and an ESP trailer 218.

At 204, a UDP encapsulated tunnel mode ESP packet is illustrated. In tunnel mode, the entire IP packet is encapsulated with a new packet header. Thus, in Tunnel Mode, ESP protection is provided for the inner IP packet (including the inner header) but the outer header remains unprotected. UDP encapsulated tunnel mode ESP packet 204 can include an IP header 220, a UDP header 222, an ESP header 224, an IP header 226, a UDP header 228, a RTP header 230, the payload 232, and an ESP trailer 234. In conventional systems, only the IP header 220 and the UDP header 222 can be compressed, resulting in a large amount of overhead since the other headers 224-230 are not compressed.

Conventional compression techniques simply compress the IP header and one layer of transport layer headers, such as UDP headers (e.g., 206, 208 or 220, 222). The remaining headers 210-214 and 224-230 remain in uncompressed mode, resulting in a large amount of overhead. This is because conventional header compression techniques are not able to compress these types of tunneled headers or extra headers. Conventional header compression schemes stop compression at the first transport (or application) layer packet. Thus, when conventional header compression schemes detect the UDP header (or another header that is not an IP header), the header compression stops, completing the chain of compression.

In accordance with various aspects presented herein, a compression header scheme is extended to look further into the packet and determine the existence of other layers of headers, including several layers of transport/application layer headers. By reviewing the additional headers 210, 212, 214 or 224, 226, 228, 230, when only integrity protection is enabled, these headers can be compressed, thus reducing the overhead. If confidentiality protection is enabled, then at least additional headers 210 or 224 can also be compressed. This enhanced header compression can increase compression efficiency.

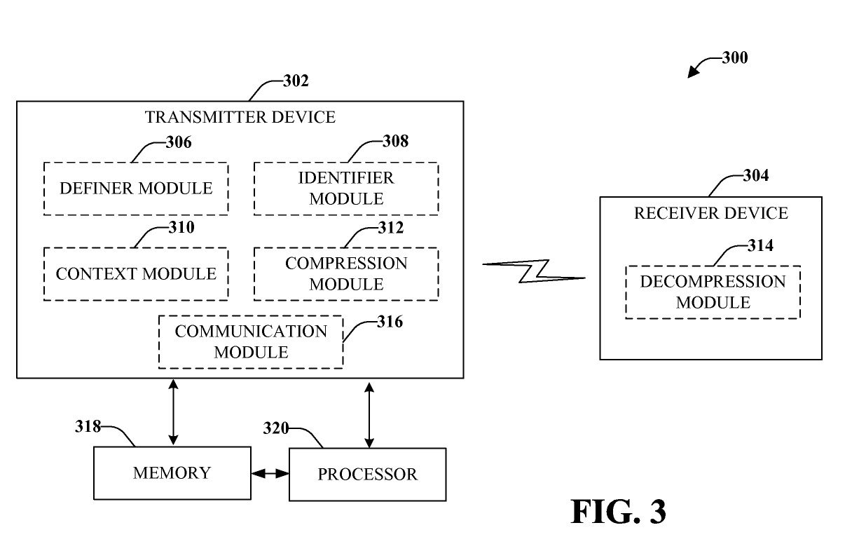

FIG. 3 illustrates a system 300 for header compression in accordance with the various aspects disclosed herein. System 300 can be included in a wireless or wireline network that includes transmitter devices and receiver devices. For purposes of simplicity, one transmitter device 302 that communicates with a single receiver device 304 is illustrated. Further, although a wireless connection is illustrated, the disclosed aspects can be applied to a wireline connection, or combinations thereof.

In accordance with some aspects, transmitter device 302 can be femtocell access point (femtocell access point 104 of FIG. 1) and receiver device 304 can be the NAT device (femtocell access point 104 of FIG. 1). In summary, compression can be performed hop-by-hop between any devices/network entities communicating using UDP encapsulated IPsec packets. It should be understood that a device or network entity can be both a transmitter and a receiver such that the device or network entity performs header compression when sending IP packets and performs header decompression when receiving compressed packets.

System 300 can be utilized when a NAT device exists between a mobile device and a gateway within an operator's network. IPsec ESP is used in IP networks over both wireline and wireless connections to protect information transmitted between IP nodes. When IPsec is utilized in an environment where a NAT device is located between the communicating IP nodes, IPsec ESP packets are often encapsulated inside UDP packets to allow NAT device traversing. The addition of the UDP header incurs more overhead for the transmitted packets.

In order to utilize enhanced header compression as disclosed herein, transmitter device 302 includes a definer module 306 that is configured to evaluate multiple layers of transport and application headers as a single header chain. The multiple layers of headers can include User Datagram Protocol headers followed by IPsec ESP headers. Definer module 306 is configured to regard ESP/UDP/IP headers as one header chain. For example, a header chain can be defined as IP/UDP/ESP or IP/UDP/ESP/UDP/RTP. In another example, a header chain can be defined as IP/UDP/ESP/IP/UDP/RTP. Definer module 306 is further configured to identify the existing layers of headers in the packet, even those headers that are transport/application headers (e.g., headers that extend beyond the IP header).

In accordance with some aspects, transmitter device 302 can include an identifier module 308 that is configured to identify the header compression profile. The header compression profile can be identified by identifier module 308 by the innermost header and includes multiple types of transport and application layer headers. For example, the identification can be enhanced ESP profile for IP/UDP/ESP or enhanced RTP profile for IP/UDP/ESP/UDP/RTP or IP/UDP/ESP/IP/UDP/RTP or a generic header compression profile where the chain of the headers are defined dynamically. In accordance with some aspects, a different version number or identification number can be utilized to identify the profile of the disclosed aspects and distinguish that profile from conventional profiles, which might be identified by the innermost header or a generic compression profile.

Further, transmitter device 302 includes a context module 310 that is configured to establish a context between a compression module 312 and a decompression module 314 (of receiver device 304). The header format used within an Robust Header Compression (ROHC) ESP profile, for example, is used as a basis for compression of ESP/UDP/IP headers with the addition of static chains and dynamic chains related to the multiple layers of transport or application layer headers, which can be established by context module 310. The static chain includes UDP static header fields between the static IP header fields and the static ESP header fields and any other static header. The dynamic chain includes the dynamic header fields for all the headers (e.g., including IP, UDP, ESP, UDP, RTP headers) in the chain.

Within each header, a large amount of the data will not change, thus the data is static and does not need to be sent in each packet. However, there might be some data that will change frequently, such as each packet or less often than each packet. This dynamic information can be sent as a dynamic chain and, each time a compressed header is sent, the dynamic chain is sent to convey the dynamic information for each header. Thus, each time a header is to be sent, the entire header does not need to be compressed and sent but only the dynamic chain information and the user data might need to be sent. The remaining static chain information (which is not sent) can be derived based on the existing context. For example, UDP header has a check sum and, if that check sum should be included in a current header, the check sum needs to be included in the dynamic chain in the compressed packet.

The context can be established before compression module 312 performs header compression. For example, the context can indicate the RTP profile that will be compressed and this RTP profile is identified and sent to receiver device 304, by a communication module 316, to establish the context. Decompression module 314 can utilize this information to establish the context. Once this information is transmitted, only data that has changed (e.g., dynamic fields) need to be resent in a subsequent packet.

Context module 310 can indicate to compression module 312 the chain of headers that are to be compressed. Compression module 312 (or another component) can retain that chain of headers in a memory 318 or other storage medium. Further, static chain information can be maintained in memory 318 or another storage medium.

Conventional systems utilize ROHC (or another compression scheme) to compress a chain of IP headers and one layer of the transport (or application) layer packet. For example, conventional systems do not compress the ESP header, UDP header and RTP header inside a UDP header. However, compression module 312 is configured to compress headers beyond the UDP. For example, in a chain of headers including IP, UDP, ESP, UDP, RTP, the payload within the ESP header (e.g., UDP, RTP, IP) might be compressed, even if those headers have been integrity protected. The compression of conventional systems would stop at the UDP header in this example.

Compression module 312 is configured to compress the multiple layers of headers as a single header chain. In accordance with some aspects, compression module 312 can compress the chain utilizing a Robust Header Compression (ROHC) framework to mitigate overhead. ROHC compresses headers of Internet packets, however, compression module 312 can extend the compression to include other layers of headers, including transport/application layer headers. In streaming applications, such as VoIP, the overhead of IP, UDP, and RTP headers can be about 40 bytes for IPv4 (and around 60 bytes for IPv6). Thus, the overhead of these headers can be sixty percent of the total amount of data being sent. While this large amount of overhead might be tolerated in wireline networks where capacity might not be a large concern, in wireless networks, with bandwidth constraints, this large amount of overhead can be burdensome. The large amount of overhead is also a major concern for backhaul connecting the femtocell access point (femtocell access point 104 of FIG. 1) to the gateway (gateway 110 of FIG. 1). Thus, ROHC or another compression technique can be utilized to reduce the headers to a few bytes. This compression is performed by compression module 312 before the information is sent by communication module 316 over the link that has limited capacity (e.g., the wireless link or the backhaul link). At receiver device 304, or at another point within the network (e.g., after the link with limited capacity), a decompression module 314 performs the reverse operation (e.g., decompresses the headers).

Memory 318 can be operatively coupled to transmitter device 302. Memory 318 can be external to transmitter device 302 or can reside within transmitter device 302. Memory 318 can store information related to identifying two or more layers of headers that comprise a User Datagram Protocol header followed by an Internet Protocol Security Encapsulated Security Payload header. In accordance with some aspects, the two or more layers of headers comprise UDP encapsulated IPsec headers including an innermost application layer header. Memory also retains instructions related to concatenating the multiple layers of headers, compressing the concatenation, and conveying the compressed concatenation in a packet, wherein the packet includes the concatenation and user data, and other suitable information related to signals transmitted and received in a communication network. At least one processor 320 can be operatively connected to transmitter device 302 (and/or memory 318) to facilitate analysis of information related to header compression in a communication network. Processor 320 can be a processor dedicated to analyzing and/or generating information transmitted and/or received by transmitter device 302, a processor that controls one or more components of system 300, and/or a processor that both analyzes and generates information transmitted and/or received by transmitter device 302 and controls one or more components of system 300.

Memory 318 can store protocols associated with compressing UDP encapsulated IPsec ESP headers, taking action to control communication between transmitter device 302 and receiver device 304, and so forth, such that system 300 can employ stored protocols and/or algorithms to achieve improved communications in a wireless or wireline network as described herein. It should be appreciated that the data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

According to some aspects, processor 320 is configured to compress IPsec headers. Included in processor 320 is a first module for identifying multiple layers of headers that comprise a User Datagram Protocol header followed by an Internet Protocol Security Encapsulated security Payload header. Processor 320 also includes a second module for concatenating the multiple layers of headers and a third module for compressing the concatenation. Further, processor 320 includes a fourth module for conveying the compressed concatenation in a packet. The packet includes the concatenation and user data. In accordance with some aspects, processor 320 includes a fifth module for identifying a static chain and a dynamic chain for each of the multiple layers of headers.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement the methodologies described herein. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

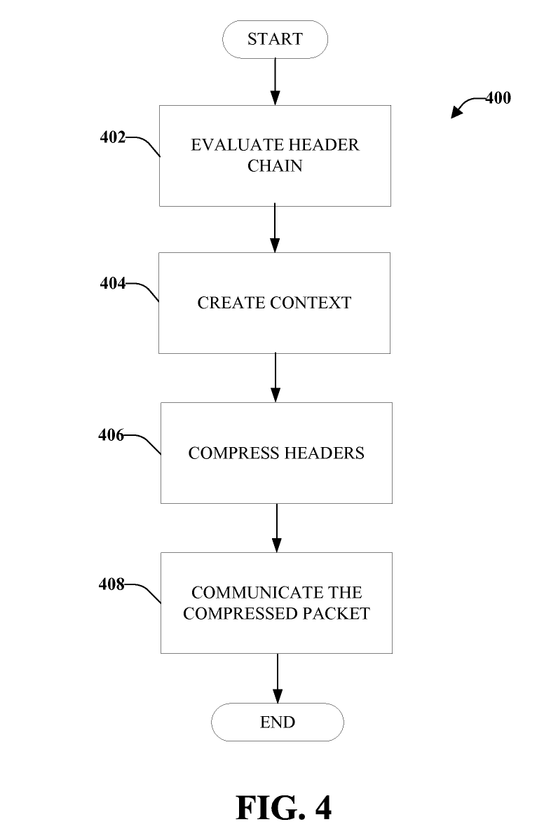

FIG. 4 illustrates a method 400 for header compression in a communication network, according to an aspect. The header compression profile of method 400 compresses UDP encapsulated IPsec ESP headers. Method 400 is configured to compress ESP/UDP/IP headers and define the header format that will be used for compressing these headers.

Method 400 starts, at 402, where a header chain is evaluated for multiple layers of transport and application layer headers. The multiple layers can comprise User Datagram Protocol header followed by an Internet Protocol Security Encapsulated Security Payload (Ipsec ESP) header. In accordance with some aspects, the multiple layers of transport or application layer headers include UDP encapsulated IPsec headers that comprise IP layer packet headers, a UDP encapsulation header, an ESP header, and if NULL encryption is used, additional IP layer or transport layer headers, and application layer headers.

At 404, a context for the chain of the multiple layers of headers is created. In accordance with some aspects, creating the context can include identifying a static chain and a dynamic chain. The static chain information is unlikely to change or can be derived by other means (e.g., destination port number, source port number), however, the dynamic chain information (e.g., check sum, IPsec SPI) might change relatively more frequently (e.g., each packet or less frequently). The static chain can include the static header fields of all the headers in the header chain to be compressed, including for example, IP static header fields, UDP static header fields, and/or ESP static header fields. The dynamic chain can include dynamic header field information of the same header chain.

At 406, the multiple layers of headers are treated as a single header chain and compressed to produce a compressed packet. The compressed packet can include at least one dynamic field for at least one of the multiple layers of headers. In accordance with some aspects, compressing the multiple layers of headers as a single header chain includes utilizing a robust header compression framework or another compression technique. In accordance with some aspects, creating the context, at 404, can include conveying the context to a receiver device before compressing the multiple layers of headers, at 406. The compressed packet is communicated to a receiver device, at 408.

In accordance with some aspects, method 400 also includes identifying a header compression profile by an inner most header or a generic profile identifier. For example, an enhanced ESP profile for IP/UDP/ESP or an enhanced RTP profile for IP/UDP/ESP/UDP/RTP or IP/UDP/ESP/IP/UDP/RTP.

According to some aspects, method 400 includes conveying the evaluated header chain to a receiver device during a context initialization. For example, both static and dynamic chain information might be conveyed during context initialization, which can be conveyed prior to compression of the data. Thus, a port number is transmitted as the port number, not as a compressed port number. In accordance with some aspects, the static chain information can be encoded in a certain manner (e.g., if normally 16 bits is used, an encoding scheme might utilize 8 bits to represent that information).

In accordance with some aspects, a computer program product can include a computer-readable medium that comprises codes for carrying out various aspects. For example, computer-readable medium can include a first set of codes for causing a computer to evaluate a header chain for multiple layers of transport and application layer headers. The multiple layers comprise a User Datagram Protocol header followed by an Internet Protocol Security Encapsulated Security Payload (IPsec ESP) header. Computer-readable medium also includes a second set of codes for causing the computer to create a context for a chain of the multiple layers of transport and application layer headers. Also included is a third set of codes for causing the computer to compress the multiple layers of headers as a single header chain to produce a compressed packet and a fourth set of codes for causing the computer to communicate the compressed packet to a receiver.

Additionally, computer-readable medium can include a fifth set of codes for causing the computer to identify a header compression profile by an inner most header or a generic compression profile. Alternatively or additionally, computer-readable medium includes a fifth set of codes for causing the computer to identify a static chain and a dynamic chain.

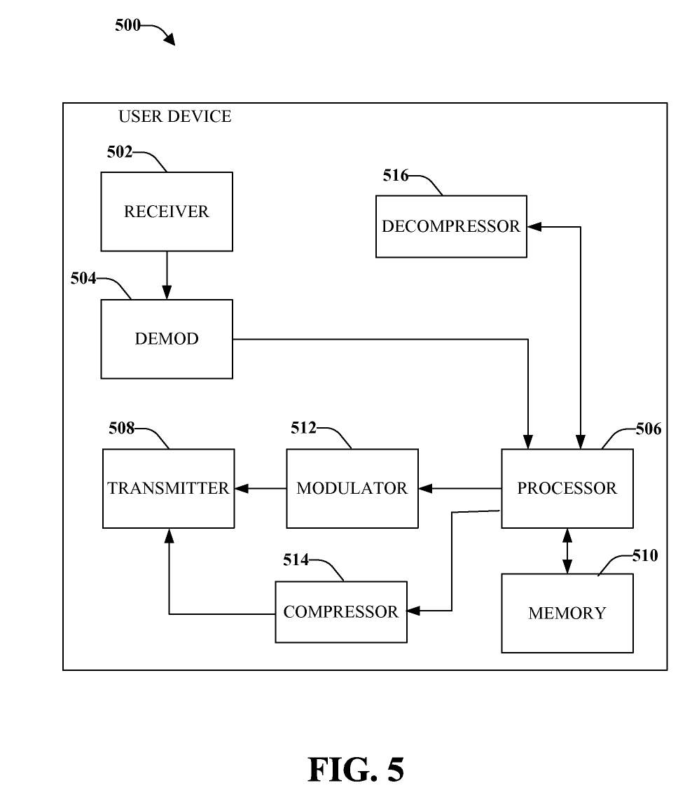

With reference now to FIG. 5, illustrated is a system 500 that facilitates compressing UDP encapsulated IPsec ESP headers in accordance with one or more of the disclosed aspects. System 500 can reside in a user device. System 500 comprises a receiver 502 that can receive a signal from, for example, a receiver antenna. The receiver 502 can perform typical actions thereon, such as filtering, amplifying, downconverting, etc. the received signal. The receiver 502 can also digitize the conditioned signal to obtain samples. A demodulator 504 can obtain received symbols for each symbol period, as well as provide received symbols to a processor 506.

Processor 506 can be a processor dedicated to analyzing information received by receiver 502 and/or generating information for transmission by a transmitter 508. In addition or alternatively, processor 506 can control one or more components of system 500, analyze information received by receiver 502, generate information for transmission by transmitter 508, and/or control one or more components of system 500. Processor 506 may include a controller component capable of coordinating communications with additional user devices.

System 500 can additionally comprise memory 510 operatively coupled to processor 506 and that can store information related to coordinating communications and any other suitable information. Memory 510 can additionally store protocols associated with header compression. It will be appreciated that the data store (e.g., memories) components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory of the subject systems and/or methods is intended to comprise, without being limited to, these and any other suitable types of memory. System 500 can further comprise a symbol modulator 512 and a transmitter 508 that transmits the modulated signal.

Transmitter 508 is further operatively coupled to a compressor 514 that is configured to compress UDP encapsulated IPsec ESP header, according to an aspect. The IPsec ESP headers can be combined and treated as a single header for purposes of compression. Further, each layer of header can include a static chain and, optionally, a dynamic chain. Receiver 502 is further operatively coupled to a decompressor 516 that is configure to decompress a compressed packet, wherein the compressed packet is decompressed into multiple layers of headers, including IPsec headers.

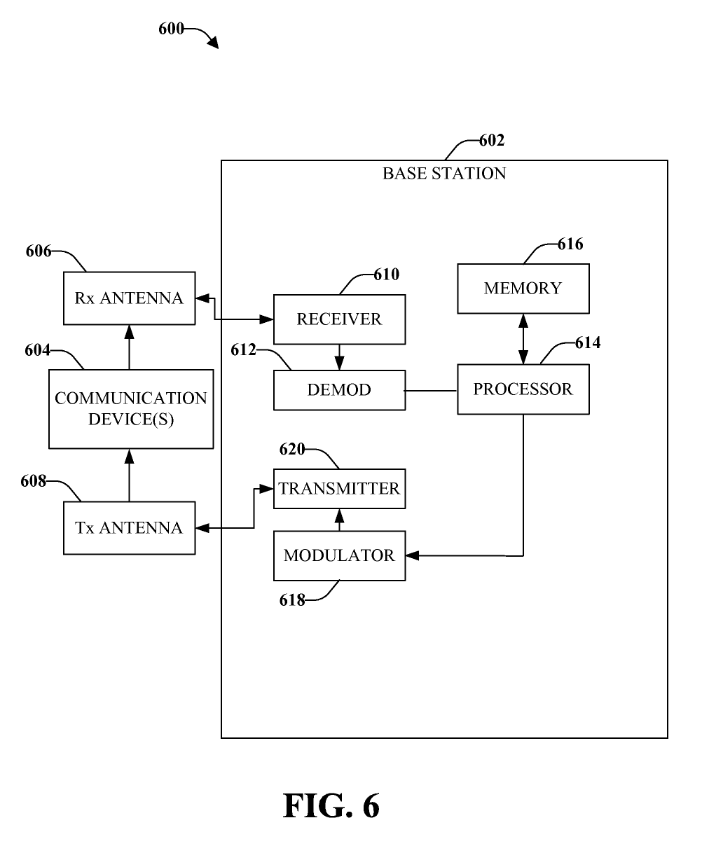

FIG. 6 is an illustration of a system 600 that facilitates compressing headers in accordance with various aspects presented herein. System 600 comprises a base station or access point 602. As illustrated, base station 602 receives signal(s) from one or more communication devices 604 (e.g., user device) by a receive antenna 606, and transmits to the one or more communication devices 604 through a transmit antenna 608.

Base station 602 comprises a receiver 610 that receives information from receive antenna 606 and is operatively associated with a demodulator 612 that demodulates received information. Demodulated symbols are analyzed by a processor 614 that is coupled to a memory 616 that stores information related to compressing UDP encapsulated IPsec ESP headers. A modulator 618 can multiplex the signal for transmission by a transmitter 620 through transmit antenna 608 to communication devices 604.

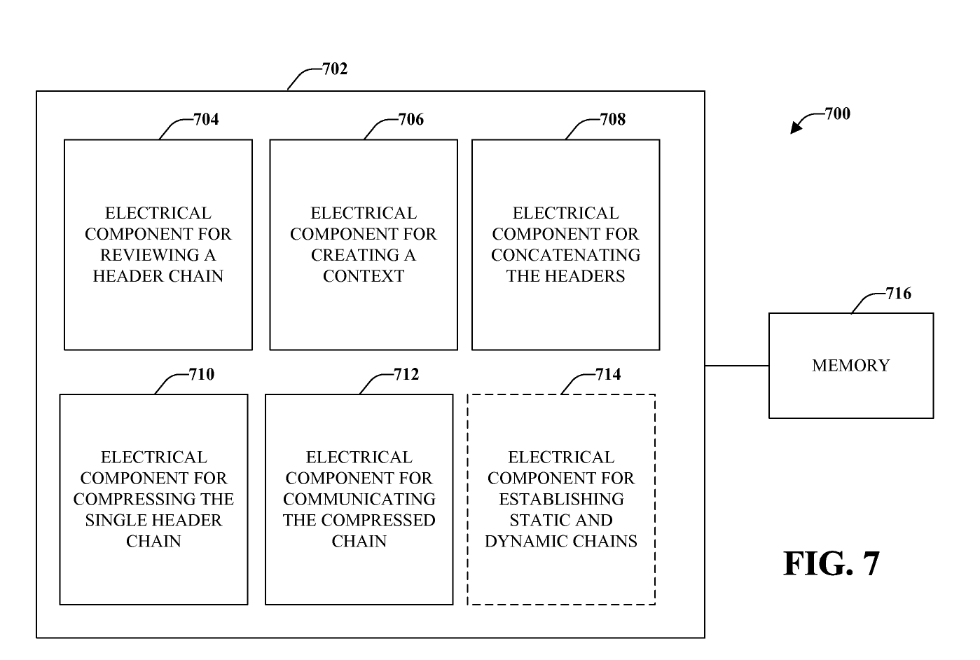

With reference to FIG. 7, illustrated is an example system 700 that compresses user datagram protocol encapsulated IPsec ESP headers in a communication environment that utilizes femtocell base stations, in accordance with an aspect. For example, system 700 may reside at least partially within a mobile device or within a femtocell base station. It is to be appreciated that system 700 is represented as including functional blocks, which may be functional blocks that represent functions implemented by a processor, software, or combination thereof (e.g., firmware).

System 700 includes a logical grouping 702 of electrical components that can act separately or in conjunction. Logical grouping 702 may include an electrical component for reviewing a header chain for multiple layers of transport and application layer headers (e.g., User Datagram Protocol headers, IP headers and IPsec headers). The IP headers can include an IP header and UDP header. The IPsec headers can include an ESP header, a UDP, header, and an IP header. In accordance with some aspects, the multiple layers of transport and application layer headers include a User Datagram Protocol header followed by an Internet Protocol Security Encapsulated Security Payload header.

Also included in logical grouping 702 is an electrical component 706 for creating a context for a chain of multiple layers of headers (e.g., User Datagram Protocol headers and IPsec headers) In accordance with some aspects, the multiple layers of transport and application layer headers can include UDP encapsulated headers that include some IP layer packet headers, a UDP encapsulated header. If NULL encryption is used, additional IP layer or transport layer headers, and some application layer headers can be included.

Also included is an electrical component 708 for concatenating the multiple headers into a single header chain. To concatenate the headers, the headers are combined and treated as a single header chain. Also included is an electrical component 710 for compressing the single header chain. In accordance with some aspects, the single header chain can be compressed utilizing a robust header compression framework or another compression technique.

Further, logical grouping 702 includes an electrical component 712 for communicating the compressed chain. At substantially the same time as the compressed chain is communicated, the payload data (e.g., user data can be communicated).

In accordance with some aspects, logical grouping 702 includes an electrical component 714 for establishing a static chain and a dynamic chain for each of the IPsec headers. The static chain can include User Datagram Protocol (UDP) static header fields either between static Internet Protocol (IP) header fields and static IP header fields or between static IP header fields and static ESP header fields. The dynamic chain includes User Datagram Protocol (UDP) dynamic header fields either between dynamic Internet Protocol (IP) header fields and dynamic ESP header fields or between static IP header fields and static IP header fields. The dynamic chain can be communicated more frequently than the static chain.

Additionally, system 700 can include a memory 716 that retains instructions for executing functions associated with electrical components 704, 706, 708, 710, 712, and 714 or other components. While shown as being external to memory 716, it is to be understood that one or more of electrical components 704, 706, 708, 710, 712, and 714 may exist within memory 716.

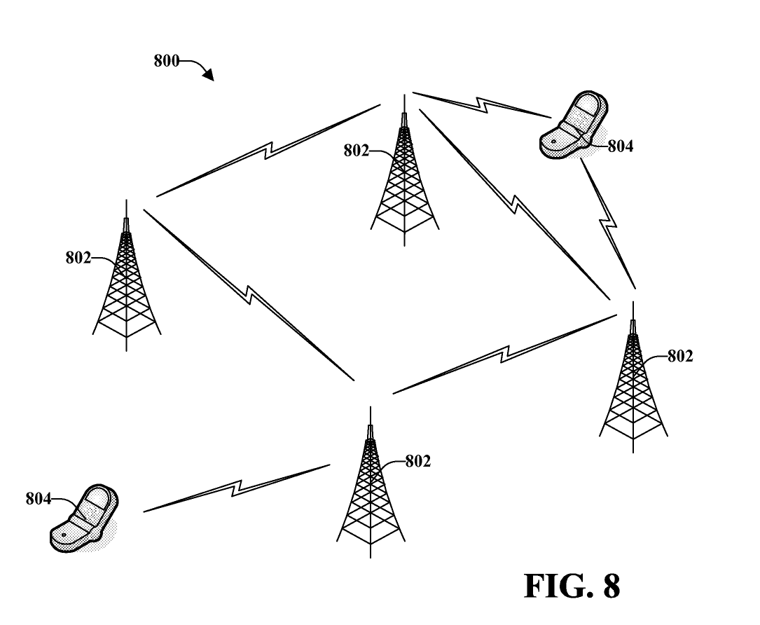

Referring now to FIG. 8, illustrated is a wireless communication system 800 in accordance with various aspects presented herein. Wireless communication system 800 can comprise one or more base stations 802 in one or more sectors that receive, transmit, repeat, and so forth, wireless communication signals to each other and/or to one or more mobile devices 804. Each base station 802 can comprise multiple transmitter chains and receiver chains (e.g., one for each transmit and receive antenna), each of which can in turn comprise a plurality of components associated with signal transmission and reception (e.g., processors, modulators, multiplexers, demodulators, demultiplexers, antennas, and so forth). Each mobile device 804 can comprise one or more transmitter chains and receiver chains, which can be utilized for a multiple input multiple output (MIMO) system. Each transmitter and receiver chain can comprise a plurality of components associated with signal transmission and reception (e.g., processors, modulators, multiplexers, demodulators, demultiplexers, antennas, and so on), as will be appreciated by one skilled in the art.

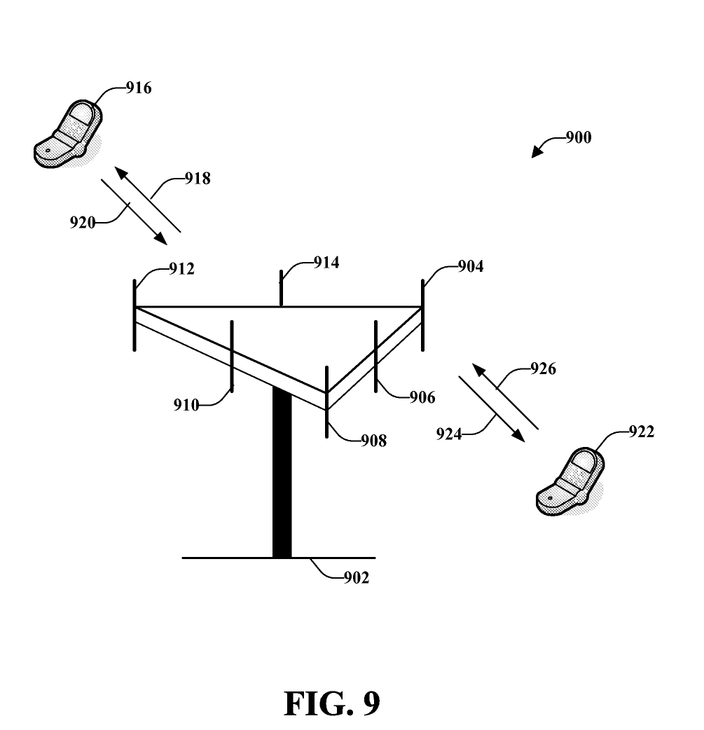

Referring now to FIG. 9, a multiple access wireless communication system 900 according to one or more aspects is illustrated. A wireless communication system 900 can include one or more base stations in contact with one or more user devices. Each base station provides coverage for a plurality of sectors. A three-sector base station 902 is illustrated that includes multiple antenna groups, one including antennas 904 and 906, another including antennas 908 and 910, and a third including antennas 912 and 914. According to the figure, only two antennas are shown for each antenna group, however, more or fewer antennas may be utilized for each antenna group. Mobile device 916 is in communication with antennas 912 and 914, where antennas 912 and 914 transmit information to mobile device 916 over forward link 918 and receive information from mobile device 916 over reverse link 920. Forward link (or downlink) refers to the communication link from the base stations to mobile devices, and the reverse link (or uplink) refers to the communication link from mobile devices to the base stations. Mobile device 922 is in communication with antennas 904 and 906, where antennas 904 and 906 transmit information to mobile device 922 over forward link 924 and receive information from mobile device 922 over reverse link 926. In an FDD system, for example, communication links 918, 920, 924, and 926 might utilize different frequencies for communication. For example, forward link 918 might use a different frequency than the frequency utilized by reverse link 920.

Each group of antennas and/or the area in which they are designated to communicate may be referred to as a sector of base station 902. In one or more aspects, antenna groups each are designed to communicate to mobile devices in a sector or the areas covered by base station 902. A base station may be a fixed station used for communicating with the terminals.

In communication over forward links 918 and 924, the transmitting antennas of base station 902 can utilize beam forming in order to improve a signal-to-noise ratio of forward links for the different mobile devices 916 and 922. Also, a base station utilizing beam forming to transmit to mobile devices scattered randomly through its coverage area might cause less interference to mobile devices in neighboring cells than the interference that can be caused by a base station transmitting through a single antenna to all the mobile devices in its coverage area.

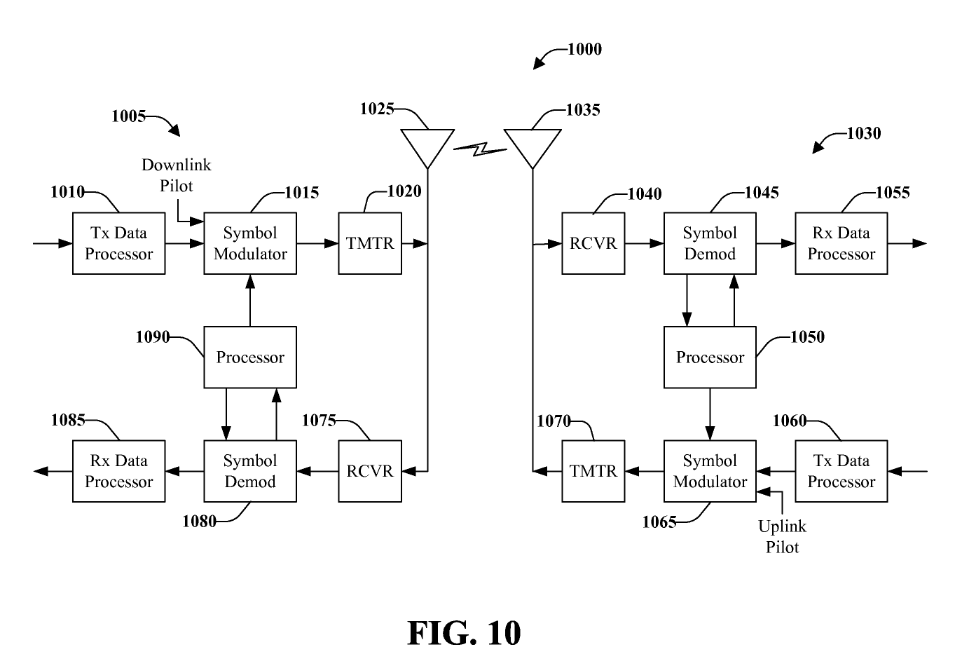

FIG. 10 illustrates an exemplary wireless communication system 1000, according to various aspects. Wireless communication system 1000 depicts one base station and one terminal for sake of brevity. However, it is to be appreciated that system 1000 can include more than one base station or access point and/or more than one terminal or user device, wherein additional base stations and/or terminals can be substantially similar or different from the exemplary base station and terminal described below. In addition, it is to be appreciated that the base station and/or the terminal can employ the systems and/or methods described herein to facilitate wireless communication there between.

Referring now to FIG. 10, on a downlink, at access point 1005, a transmit (TX) data processor 1010 receives, formats, codes, interleaves, and modulates (or symbol maps) traffic data and provides modulation symbols (“data symbols”). A symbol modulator 1015 receives and processes the data symbols and pilot symbols and provides a stream of symbols. A symbol modulator 1015 multiplexes data and pilot symbols and obtains a set of N transmit symbols. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

A transmitter unit (TMTR) 1020 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1025 to the terminals. At terminal 1030, an antenna 1035 receives the downlink signal and provides a received signal to a receiver unit (RCVR) 1040. Receiver unit 1040 conditions (e.g., filters, amplifies, and frequency downconverts) the received signal and digitizes the conditioned signal to obtain samples. A symbol demodulator 1045 obtains Nreceived symbols and provides received pilot symbols to a processor 1050 for channel estimation. Symbol demodulator 1045 further receives a frequency response estimate for the downlink from processor 1050, performs data demodulation on the received data symbols to obtain data symbol estimates (which are estimates of the transmitted data symbols), and provides the data symbol estimates to an RX data processor 1055, which demodulates (i.e., symbol demaps), deinterleaves, and decodes the data symbol estimates to recover the transmitted traffic data. The processing by symbol demodulator 1045 and RX data processor 1055 is complementary to the processing by symbol modulator 1015 and TX data processor 1010, respectively, at access point 1005.

On the uplink, a TX data processor 1060 processes traffic data and provides data symbols. A symbol modulator 1065 receives and multiplexes the data symbols with pilot symbols, performs modulation, and provides a stream of symbols. A transmitter unit 1070 then receives and processes the stream of symbols to generate an uplink signal, which is transmitted by the antenna 1035 to the access point 1005.

At access point 1005, the uplink signal from terminal 1030 is received by the antenna 1025 and processed by a receiver unit 1075 to obtain samples. A symbol demodulator 1080 then processes the samples and provides received pilot symbols and data symbol estimates for the uplink. An RX data processor 1085 processes the data symbol estimates to recover the traffic data transmitted by terminal 1030. A processor 1090 performs channel estimation for each active terminal transmitting on the uplink.

Processors 1090 and 1050 direct (e.g., control, coordinate, manage, . . . ) operation at access point 1005 and terminal 1030, respectively. Respective processors 1090 and 1050 can be associated with memory units (not shown) that store program codes and data. Processors 1090 and 1050 can also perform computations to derive frequency and impulse response estimates for the uplink and downlink, respectively.

For a multiple-access system (e.g., FDMA, OFDMA, CDMA, TDMA, and the like), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof With software, implementation can be through modules (e.g., procedures, functions, and so on) that perform the functions described herein. The software codes may be stored in memory unit and executed by the processors 1090 and 1050.

It is to be understood that the aspects described herein may be implemented by hardware, software, firmware or any combination thereof When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine-readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method for header compression in a communication network, comprising:
evaluating a header chain for more than one layer of transport and application layer headers, wherein the more than one layer comprises a User Datagram Protocol header followed by an Internet Protocol Security Encapsulated Security Payload (IPsec ESP) header;
creating a context for a chain of the more than one layer of transport and application layer headers;
compressing the more than one layer of transport and application layer headers as a single header chain to produce a compressed packet; and
communicating the compressed packet to a receiver device.

2. The method of claim 1, wherein the more than one layer of transport and application layer headers comprise User Datagram Protocol (UDP) encapsulated IPsec headers, wherein the UDP encapsulated headers comprise IP layer packet headers, a UDP encapsulation header, an ESP header, and if NULL encryption is used, additional IP layer or transport layer headers, and application layer headers.

3. The method of claim 1, wherein the compressed packet comprises at least one dynamic field for at least one of the more than one layer of transport and application layer headers.

4. The method of claim 1, wherein creating the context comprises conveying the context to the receiver device before compressing the more than one layer of transport and application layer headers.

5. The method of claim 1, further comprises identifying a header compression profile by an inner most header or a generic compression profile.

6. The method of claim 1, further comprises conveying the evaluated header chain to the receiver device during a context initialization.

7. The method of claim 1, wherein creating the context comprises identifying a static chain and a dynamic chain.

8. The method of claim 7, wherein the static chain comprises User Datagram Protocol (UDP) static header fields either between static Internet Protocol (IP) header fields and static IP header fields or between the static IP header fields and static ESP header fields.

9. The method of claim 7, wherein the dynamic chain comprises User Datagram Protocol (UDP) dynamic header fields either between dynamic Internet Protocol (IP) header fields and dynamic ESP header fields or between static IP header fields and static IP header fields.

10. The method of claim 1, wherein compressing the more than one layer of transport and application layer headers as the single header chain comprises utilizing a robust header compression framework.

11. A communications apparatus, comprising:
a memory that retains instructions related to identifying two or more layers of headers that comprise a User Datagram Protocol header followed by an Internet Protocol Security Encapsulated Security Payload header, concatenating the two or more layers of headers, compressing the concatenation, and conveying the compressed concatenation in a packet, wherein the packet includes the concatenation and user data; and
a processor, coupled to the memory, configured to execute the instructions retained in the memory.

12. The communications apparatus of claim 11, wherein the two or more layers of headers comprise UDP encapsulated IPsec headers including an innermost application layer header.

13. The communications apparatus of claim 11, the memory retains further instructions related to identifying a static chain and a dynamic chain for each of the two or more layers of headers, wherein the static chain is communicated once and the dynamic chain is communicated frequently.

14. The communications apparatus of claim 13, wherein the static chain comprises User Datagram Protocol (UDP) static header fields either between static Internet Protocol (IP) header fields and static IP header fields or between static IP header fields and static ESP header fields.

15. The communications apparatus of claim 13, wherein the dynamic chain comprises User Datagram Protocol (UDP) dynamic header fields either between dynamic Internet Protocol (IP) header fields and dynamic ESP header fields or between static IP header fields and static IP header fields.

16. The communications apparatus of claim 11, wherein the memory retains further instructions related to creating a context for a chain of the two or more layers of headers and communicating the context to a receiver device before compressing the concatenation.

17. A communications apparatus that compresses user datagram protocol encapsulated IPsec ESP headers, comprising:
means for reviewing a header chain for User Datagram Protocol headers and IPsec headers;
means for creating a context for a chain of the User Datagram Protocol headers and the IPsec headers;
means for concatenating the User Datagram Protocol headers and the IPsec headers into a single header chain;
means for compressing the single header chain into a compressed chain; and
means for communicating the compressed chain with payload data.

18. The communications apparatus of claim 17, wherein the IPsec headers include an IP header, a UDP header, and an ESP header.

19. The communications apparatus of claim 17, further comprising means for establishing a static chain and a dynamic chain for each of the IPsec headers, wherein the dynamic chain is communicated more frequently than the static chain.

20. The communications apparatus of claim 17, wherein the means for compressing the single header chain utilizes a robust header compression framework.

21. A computer program product, comprising:
a computer-readable medium comprising:
a first set of codes for causing a computer to evaluate a header chain for multiple layers of transport and application layer headers, wherein the multiple layers comprise a User Datagram Protocol header followed by an Internet Protocol Security Encapsulated Security Payload (Ipsec ESP) header;
a second set of codes for causing the computer to create a context for a chain of the multiple layers of transport and application layer headers;
a third set of codes for causing the computer to compress the multiple layers of headers as a single header chain to produce a compressed packet; and
a fourth set of codes for causing the computer to communicate the compressed packet to a receiver device.

22. The computer program product of claim 21, further comprising a fifth set of codes for causing the computer to identify a header compression profile by an inner most header or a generic compression profile.

23. The computer program product of claim 21, further comprises a fifth set of codes for causing the computer to identify a static chain and a dynamic chain, wherein the static chain comprises User Datagram Protocol (UDP) static header fields either between static Internet Protocol (IP) header fields and static IP header fields or between static IP header fields and static ESP header fields and wherein the dynamic chain comprises User Datagram Protocol (UDP) dynamic header fields either between dynamic Internet Protocol (IP) header fields and dynamic ESP header fields or between static IP header fields and static IP header fields.

24. At least one processor configured to compress IPsec headers, comprising:
a first module for identifying multiple layers of headers, wherein the multiple layers of headers comprise a User Datagram Protocol header followed by an Internet Protocol Security Encapsulated Security Payload header;
a second module for concatenating the multiple layers of headers;
a third module for compressing the concatenation; and
a fourth module for conveying the compressed concatenation in a packet, wherein the packet includes the concatenation and user data.

25. The at least one processor of claim 24, further comprises a fifth module for identifying a static chain and a dynamic chain for each of the multiple layers of headers.
